(19) United States
(12) Patent Application Publication
(10) Pub. No.: US 2022/0410545 A1
(43) Pub. Date: Dec. 29, 2022

(54) Inverted Tabbed Induction Liner

(71) Applicant: Selig Sealing Products, Inc., Forrest, IL (US)

(72) Inventor: Robert William Thorstensen-Woll, Barrie, Ontario (CA)

(21) Appl. No.: 17/779,324

(22) PCT Filed: Nov. 25, 2020
(86) PCT No.: PCT/US20/62231

§ 371 Date: May 24, 2022

Related U.S. Application Data
(60) Provisional application No. 62/941,912, filed on Nov. 29, 2019.

(51) Int. Cl. B32B 27/08; B32B 7/14; B32B 5/18; B32B 3/08

(52) U.S. Cl. CPC B32B 27/08; B32B 7/14; B32B 5/18; B32B 3/08; B32B 2250/02; B32B 2250/03; B32B 2250/24; B32B 2250/44; B32B 2266/02; B32B 2581/00; B32B 2435/02; B32B 2307/412; B32B 2307/414; B32B 2307/7244; B32B 2307/7246; B32B 2307/304; B32B 2307/748

(57) ABSTRACT

Various forms of tabbed sealing members are described along with the laminates from which the sealing members are formed. In some forms, the tabbed sealing members may be considered inverted tabbed sealing members for induction sealing as the induction heating layer is provided in the upper laminate instead of the lower laminate. In this regard, the induction heating layer is positioned further from the heat seal, contrary to conventional tabbed sealing members.

### CROSS-REFERENCE TO RELATED APPLICATIONS

This application claims benefit of U.S. Provisional Application No. 62/941,912, filed Nov. 29, 2019, which is hereby incorporated herein by reference in its entirety.

### FIELD

The disclosure relates to pull-tab sealing members for sealing the mouth of a container, and more particularly, to pull-tab sealing members wherein an induction heating layer is positioned in an upper laminate and/or the seal to the container is a differential seal.

### BACKGROUND

It is often desirable to seal the opening of a container using a removable or peelable seal, sealing member, or inner seal. Often a cap or other closure is then screwed or placed over the container opening capturing the sealing member therein. In use, a consumer typically removes the cap or other closure to gain access to the sealing member and then removes or otherwise peels the seal from the container in order to dispense or gain access to its contents.

Initial attempts at sealing a container opening utilized an induction- or conduction-type inner seal covering the container's opening where the seal generally conformed to the shape of the opening such that a circular container opening was sealed with a round disk approximately the same size as the opening. These prior seals commonly had a lower heat activated sealing layer to secure a periphery of the seal to a rim or other upper surface surrounding the container's opening. Upon exposing the seal to heat, the lower layer bonded to the container's rim. In many cases, these seals included a foil layer capable of forming induction heat to activate the lower heat seal layer. These prior seals tended to provide good sealing, but were often difficult for a consumer to remove because there was nothing for the consumer to grab onto in order to remove the seal. Often, the consumer needed to pick at the seal's edge with a fingernail because there was little or no seal material to grasp.

Other types of seals for containers include a side tab or other flange that extended outwardly from a peripheral edge of the seal. These side tabs are generally not secured to the container rim and provide a grasping surface for a consumer to hold and peel off the seal. These side tabs, however, extend over the side of the container rim and often protrude into a threaded portion of the closure. If the side tab is too large, this configuration may negatively affect the ability of the seal to form a good heat seal. The side tabs (and often the seal itself) can be deformed or wrinkled when the closure or other cap is placed on the container due to contact between the closure (and threads thereof) and tabbed part of the seal. To minimize these concerns, the side tabs are often very small, thus providing little surface area or material for a consumer to grasp in order to remove the seal.

Yet other types of seals include a sealing member having a tab defined on the top of the seal. One approach of these prior seals includes a partial layer of coated pressure sensitive adhesive to secure the tab to a layer of metal foil. The tab was formed by a full layer extending across the entire surface of the sealing member, but the full layer was only bonded to half of the seal to form the tab. This type of top-tabbed seal offered the advantage of a larger tab, which provided more grasping area for the consumer to hold and peel off the seal, but required a full additional layer of material in order to form the tab. In other approaches, the seal may include a tab formed from the additional full layer of film combined with an additional full layer of adhesive utilizing a part paper or part polymer layer, called a tab stock, to form the tab. This part layer is inserted between the additional full layer of adhesive and lower seal portions to prevent the tab from sticking to the layers below, which formed the tab.

However, even in these tabbed forms, the tab may still be difficult for a user to remove from a container. For example, oftentimes, an induction heating layer, such as a metal foil, is positioned in a lower laminate so as to be near the heat seal for sealing to the container. The metal foil typically needs to be insulated and/or provided with additional strength so as to not tear. By adding these extra layers, the lower laminate may become fairly thick and/or may still tear due to the removal forces. Further, by including a metal foil layer in the lower laminate, a user will not be able to view the contents of the container prior to removal of the seal. Therefore, it may be desirable to relocate the metal foil layer and/or downgauge some of the layers to save expense and to decrease the overall seal thickness.

Additionally, there have been other difficulties with tabbed seals such as providing pour spouts formed by the tabbed seal. Oftentimes when tabbed seals are designed to tear to provide a spout, one of more of the layers tears unevenly or not at all, thereby leaving a jagged remnant on the container and/or being completely removed such that no spout is formed.

### SUMMARY

Various forms of tabbed sealing members are described along with the laminates from which the sealing members are formed. In some forms, the tabbed sealing members may be considered inverted tabbed sealing members for induction sealing as the induction heating layer is provided in the upper laminate instead of the lower laminate. In this regard, the induction heating layer is positioned further from the heat seal, contrary to conventional tabbed sealing members.

According to one form, a tabbed sealing member for sealing to a rim surrounding a container opening is provided. The sealing member includes a multi-layer laminate including an upper laminate portion partially bonded to a lower laminate portion forming a gripping tab. The gripping tab may be defined wholly within a perimeter of the sealing member. The gripping tab is configured for removing the sealing member from the container opening. The lower laminate portion is positioned below the gripping tab and includes at least a heat seal layer for bonding to the container rim and a support layer above the heat seal layer. The upper laminate includes an induction heating layer for providing heat to the heat seal layer in the lower laminate portion.

In accordance with one form, a tabbed sealing member for sealing to a rim surrounding a container opening is provided. The sealing member includes a multi-layer laminate including an upper laminate portion partially bonded to a lower laminate portion forming a gripping tab. In one form, the gripping tab is defined wholly within a perimeter of the sealing member. The gripping tab is configured for removing the sealing member from the container opening. The lower laminate portion is positioned below the gripping tab and includes at least a heat seal layer for bonding to the container rim and a support layer above the heat seal layer. The upper laminate includes an induction heating layer for providing heat to the heat seal layer in the lower laminate portion. The heat seal layer includes a plurality of adhesive portions with a first adhesive portion configured to provide a first bond strength to the container when installed, and a second adhesive portion configured to provide a first bond strength to the container when installed to provide a differential peel of the heat sealing layer.

In one form, a laminate for forming a tabbed sealing member is provided. The laminate includes an upper laminate portion and a lower laminate portion. The upper laminate portion includes an insulating layer and an induction heating layer. The lower laminate portion includes at least a heat seal layer for bonding to the container rim and a support layer above the heat seal layer. The upper laminate portion is partially bonded to a lower laminate portion and configured to form a gripping tab when the laminate is formed into the sealing member.

According to one form, the tabbed sealing member further includes an insulating layer in the upper laminate.

In accordance with one form, the tabbed sealing member further includes a polymer foam layer and a polymer film layer.

In one form, the heat seal layer comprises adhesives with different bond strengths such that the heat seal layer provides a differential peel when removed from a container.

According to one form, the tabbed sealing member further includes a tab layer in at least one of the lower laminate portion and the upper laminate portion.

In accordance with one form, at least a portion of the lower laminate portion may be transparent, translucent, or a combination thereof.

In one form, at least a portion of the lower laminate is configured to remain on a container when the tabbed sealing member is removed from the container to form a pour spout.

According to one form, the tabbed sealing member further includes a liner.

In accordance with one form, the lower laminate portion further includes a barrier film selected from the group consisting of SiOx, AlOx, EVOH, and combinations thereof.

These and other aspects may be understood more readily from the following description and the appended drawings.

### BRIEF DESCRIPTION OF THE DRAWINGS

FIG. 1 is an exploded view of a prior tabbed sealing member having a foil layer in a lower laminate;

FIG. 2 is an exploded view of one form of a tabbed sealing member;

FIG. 3 is an exploded view of another form of a tabbed sealing member;

FIG. 4 is a top view of a tabbed sealing member installed on a container where the tab has been lifted;

FIG. 5 is a top view of the tabbed sealing member of FIG. 4 whereby the tab has been folded over to view the interior contents of the container;

FIG. 6 is a top view of a plurality of tabbed sealing members installed on containers where the tabs are lifted showing different sizes of tabs;

FIG. 7 is a top perspective view of the tabbed sealing member of FIG. 4 whereby the contents of the container are visible;

FIG. 8 is a perspective view of a tabbed sealing member whereby a remainder of the lower laminate is on the container to form a pour spout for liquids;

FIG. 9 is a perspective view of a tabbed sealing member whereby a remainder of the lower laminate is on the container to form a pour spout for powders;

FIG. 10 is an exploded view of a two-piece tabbed sealing member;

FIG. 11 is an exploded view of another form of tabbed sealing member;

FIG. 12 is an exploded view of another form of tabbed sealing member; and

FIG. 13 is a perspective view of one form of assembling a laminate used to form a tabbed sealing member.

### DETAILED DESCRIPTION

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

A pull tab sealing member for a container is described herein containing an upper laminate having a pull tab bonded to a lower laminate capable of being heat sealed to a container's mouth or opening.

For simplicity, this disclosure generally may refer to a container or bottle, but the sealing members herein may be applied to any type of container, bottle, package or other apparatus having a rim or mouth surrounding an access opening to an internal cavity. In this disclosure, reference to upper and lower surfaces and layers of the components of the sealing member refers to an orientation of the components as generally depicted in figures and when the sealing member is in use with a container in an upright position and having an opening at the top of the container. Different approaches to the sealing member will first be generally described, and then more specifics of the various constructions and materials will be explained thereafter. It will be appreciated that the sealing members described herein, in some cases, function in both a one-piece or two-piece sealing member configuration. A one-piece sealing member generally includes just the sealing member bonded to a container rim. A cap or closure may be also used therewith. A two-piece sealing member includes the sealing member temporarily bonded to a liner. In this construction, the sealing member is bonded to a container's rim, and the liner is configured to separate from the sealing member during heating to be retained in a cap or other closure used on the container. In a two-piece construction, a wax layer, for example, may be used to temporarily bond the sealing member to a liner. Other types of releasable layers may also be used to provide a temporary bond between the seal and liner, but the releasable layers are generally heat activated.

As discussed above, tabbed seals can suffer from problems associated with the thickness and placement of certain layers. This can result in thicker seals and may also cause problems with removal of the seal.

After a tabbed seal is applied to a container the consumer removes the seal by way of grasping the tab and peeling the seal away from the container lip. The best method understood in removing the liner is to grasp and peel at the tab or “hinge” point of the seal, what can be described as a “saddle” peel. If the consumer pulls up from the center or mid regions of the tab the amount of force required to remove the seal becomes excessive as the force is spread across a larger region of sealed area. Since the removal force can be excessive, there is need to design a seal system with high internal bond strength and tear resistance. Prior systems may require a heavy 92 to 100 GA PET film with 2 mil EVA sealant that achieves a bond strength of 3200 g/inch minimum against the base foam liner. The foam is composed of high density polyethylene and the fracture strength must be capable of resisting the 3200 g/inch requirement without tearing.

The design presented herein may be used to change the dynamics of seal removal. The foil and film layer are applied above the tabbing component allowing for more intimate contact between the tab and the sealant thus decreasing the effect of the foam spreading out the force upon liner removal.

The lower laminate portion can be manufactured as a continuous component of the primary liner, or made to separate or peel cleanly with or without tamper evidence, thus providing a partial covering of the container orifice.

One version of the design involves the application of the tab component to the base foil/foam liner and the fusion of the sealant layer with the tab trapping layer. This may be achieved by using a co-ex PET film coating along with about 2 mil EVA. The EVA was adhered to the foil side of the backing liner as opposed to the standard process where the EVA is applied to the foam side.

The resulting structure produces a novel seal that allows for visibility of the print design applied to the half moon tab within the lined closure, in addition to giving the consumer the advantage of seeing the contents of the sealed package through the liner.

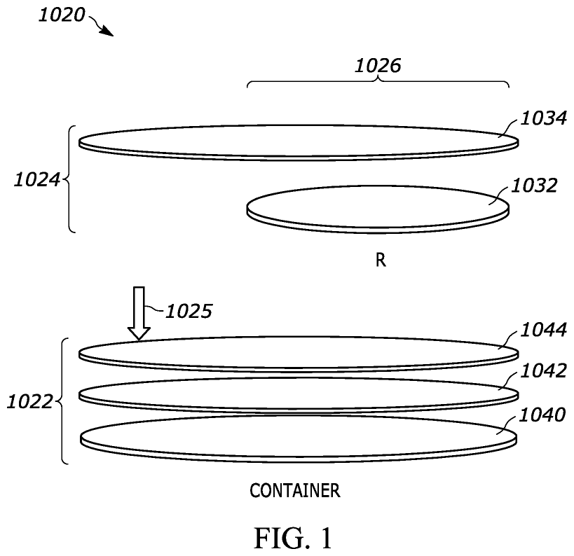

A first form of tabbed seal is shown in FIG. 1. More specifically, tabbed seal 1020 is shown in the form of a prior tabbed seal such as a traditional Lift N Peel™ structure which is manufactured by building a foam backed induction liner and binding a tab to the top foam component of this liner. The half moon tab component is applied using thermal polymer adhesion (extrusion or direct thermal lamination).

Tabbed seal 1020 includes a lower laminate portion 1022 and an upper laminate portion 1024 partially bonded thereto. In one form, a free tab portion 1026 is formed whereby the upper laminate portion 1024 is not bonded to the lower laminate portion 1022 in the area “R”, but is bonded at arrow 1025. In this form, the free tab portion 1026 may be grasped by a user to remove the tabbed sealing member 1020 from a container. In one form, the free tab portion may include a tab layer 1032, though the tab layer 1032 may alternatively be included in the lower laminate portion 1022. The tab layer 1032 helps provide a release between the lower and upper laminate portions 1022,1024.

The upper laminate portion 1024 may be bonded to the lower laminate portion 1022 in a variety of different manners, such as using a polymer film layer 1034. Polymer film layer may take a variety of forms, such as a coextruded film. The coextruded film may take a variety of forms and include a variety of different combinations of materials to provide strength and/or adhesive properties. One form may include polyethylene terephthalate (PET) for strength coextruded with another polymer for adhesive properties. The additional polymer may be used as the adhesive between the lower and upper portions 1022,1024.

The lower laminate portion 1022 may include any number of different layers, laminates, coatings, adhesives, and the like. In one form, such as shown in FIG. 1, the lower laminate portion 1022 includes a seal layer 1040, such as a heat seal and the like. The lower laminate portion 1022 may also include an induction heating layer 1042. The induction heating layer 1042 can provide a variety of different functions, such as a moisture barrier, oxygen barrier, as well as being an induction heating layer. When using heat to adhere the tabbed seal 1020 to a container, the induction heating layer 1042 may take the form of a metal foil to provide heat to the seal layer 1040 during an induction heating operation. The lower laminate portion 1022 may also include an insulation layer 1044. The insulating layer 1044 may take a variety of forms, such as a polymer foam and/or polymer film. Typically, the insulating layer 1044 must be sufficiently strong so as to not tear during seal removal.

As can be seen from the embodiment shown in FIG. 1, the lower laminate portion 1022 typically includes the induction heating layer 1042, which is oftentimes a metal foil. This layer is not transparent or translucent such that it prevents a user from seeing the content of the container.

Further, as noted above, the layers in the lower laminate portion 1022 must be sufficiently thick so as to not tear during seal removal. Oftentimes if one or more of these layers tear, the tearing is uneven, leaving jagged pieces on the container that are problematic for the user. The layers in the lower laminate portion 1022 are also oftentimes thick so as to provide sufficient heat from the induction layer, thus requiring a thicker material to provide the heat, along with a thicker insulating layer to prevent excessive heat traveling upwards to the top of the seal.

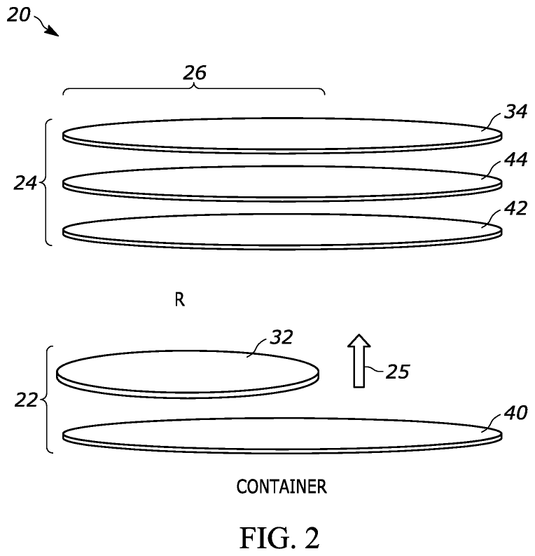

Many of the embodiments presented below, on the other hand, proceed contrary to the above conventional wisdom to achieve unique functionality and performance. For example, as shown in FIG. 2, an exploded view of tabbed sealing member 20 is shown having a lower laminate portion 22 and an upper laminate portion 24 partially bonded thereto. Similar to the embodiment in FIG. 1, the sealing member 20 includes a lower heat seal layer 40 in the lower laminate portion 22. Further, the upper laminate portion 24 may be partially bonded to the lower laminate portion 22, such as at arrow 25. In this form, tab portion 26 may be graspable by a user. The letter “R” indicates a release portion between the lower and upper laminate portions 22,24. Further, in some forms, a release layer may be positioned on at least one of the lower and upper laminate portions 22,24 to help facilitate release therebetween.

However, many of the other layers that were in the lower laminate portion 1022 are not in the lower laminate portion 22. For example, induction heating layer 42 is positioned in the upper laminate portion 24 along with insulating layer 44. Further, in the form shown in FIG. 2, the tab layer 32 may be moved to the lower laminate portion 22. The upper laminate portion 24 may still include a polymer support layer 34.

It may be appreciated that, in some forms, the lower laminate portion 1022 does not include an induction layer, such as a foil. Further, some forms may include a lower laminate portion that is free of most layers except for a heat seal, possibly a tab layer, and/or possibly a thin support layer. In some forms, the support layer or support material may be incorporated into the heat seal layer. Therefore, in some forms, the lower laminate consists of just a heat seal layer, which may or may not include a support material. In other forms, the lower laminate consists of a heat seal layer and a tab layer.

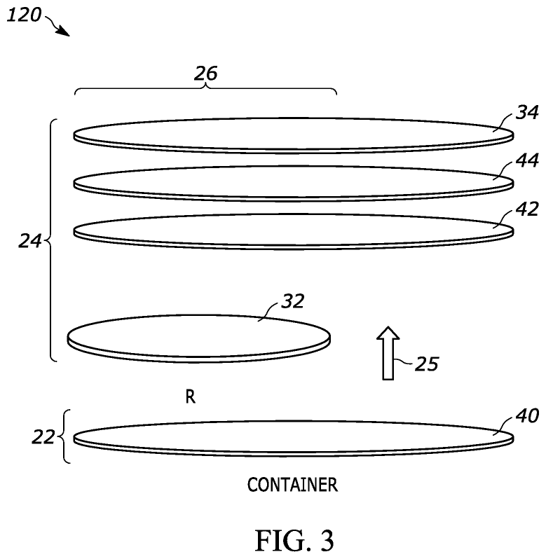

Tabbed sealing member 120 shown in FIG. 3 is similar to the tabbed sealing member 20 shown in FIG. 2. One primary difference is the placement of the tabbed layer 32. In tabbed sealing member 120, the tab layer 32 may be positioned in the upper laminate portion 24 such that generally the only layer in the lower laminate portion 22 is the heat seal layer 40. It should be appreciated that the heat seal layer 40 as well as other heat seal layers described herein may be a combination of two or more materials, such as a coextrusion of multiple materials whereby a first material is an adhesive and a second material may provide extra support and/or strength.

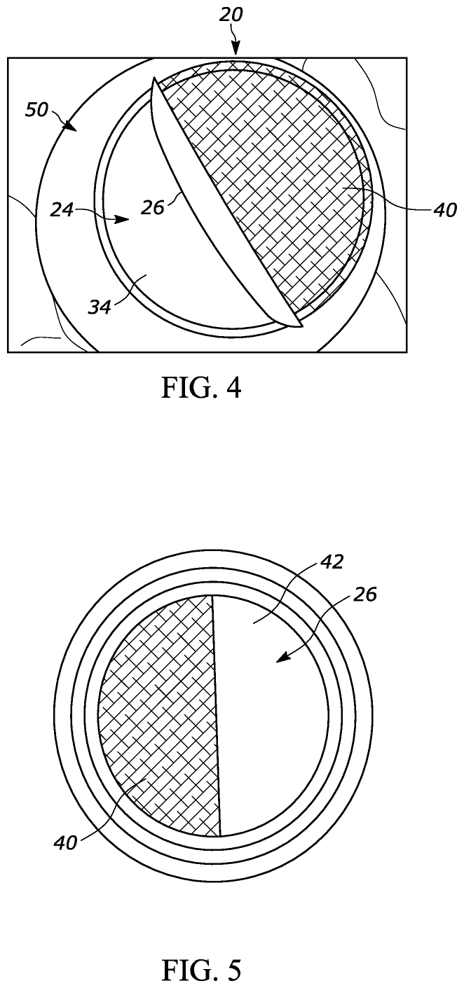

The embodiments shown in FIGS. 2 and 3 can provide unique functionality and advantages compared to the embodiment shown in FIG. 1. One such difference is shown in FIGS. 4-7 whereby a user may view the contents of container 50 when the tab 26 is lifted. Further, as seen in these figures, the lower laminate portion 2 can include printing that provides a unique configuration such that it almost appears as if the printing is floating above the contents of the container 50. By having such visibility, the printing can help provide tamper evidence and/or evidence of counterfeit seals and containers.

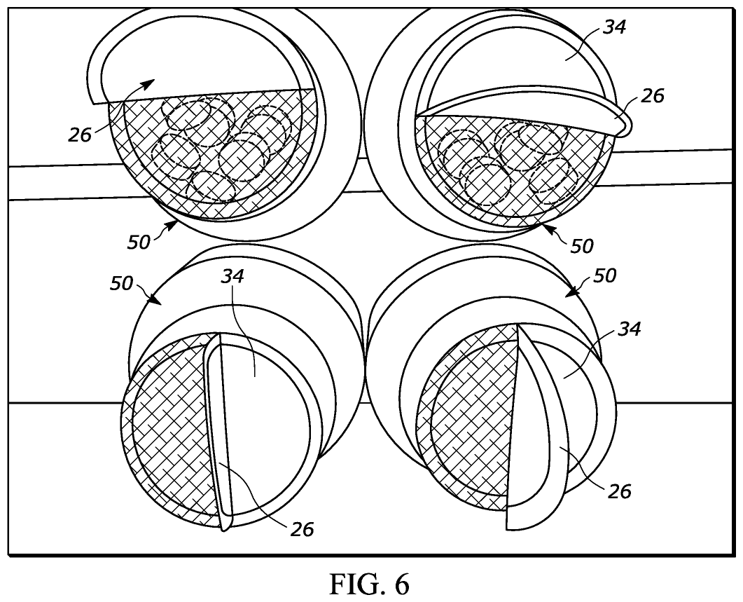

FIG. 6 illustrates a number of containers 50 having tabbed seals 20 with various sized tabs. For example, as shown in the upper left-hand corner, the tab 26 is larger than 50% of the surface area of the seal such that more than 50% of the container opening is visible and the contents seen. Other embodiments may have approximately 50% of the container opening visible, such as shown in the lower left-hand corner, whereas other forms may have less than 50% of the container opening visible. The size of the visible portion into the container can be readily modified based on the relative size of the tab.

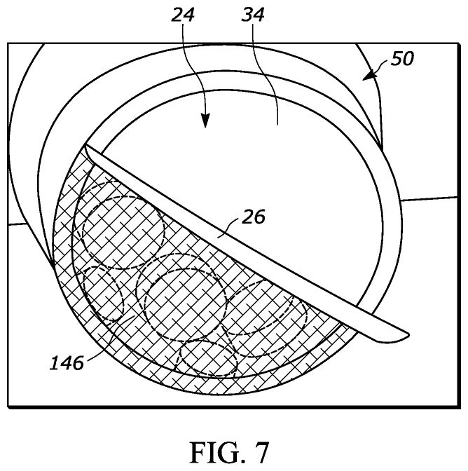

FIG. 7 presents an embodiment whereby the internal contents are readily visible. In this form, tablets 146 are seen through the lower laminate portion 22. It should be appreciated that the tabbed seals described herein may be used with a variety of different materials in containers. In this form, tablets are shown. However, other forms including, but not limited to, powders, solids, liquids, and the like may be used. As noted above, the embodiments described herein may provide a user with the ability to view the contents when the tab is lifted.

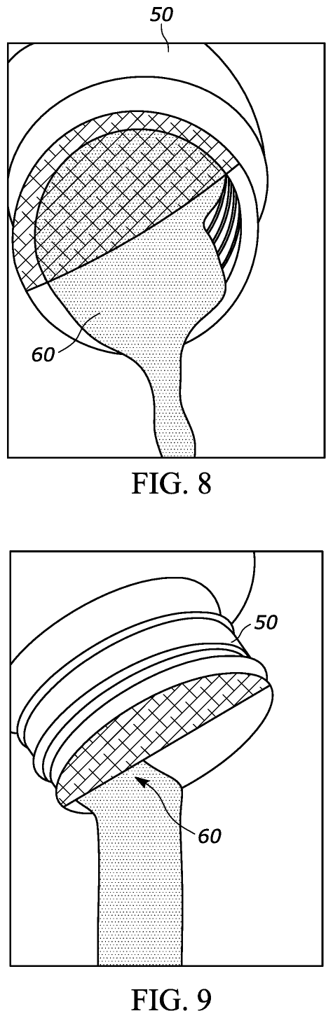

Further functionality of the tabbed seals is shown in FIGS. 8 and 9. In this form, as the tab 26 is pulled by a user, a remnant 60 of the lower laminate portion remains on the container to thereby form a spout. In some forms, the lower laminate portion 22 below the tab 26 remains on the container such that the lower laminate portion 22 tears and/or ruptures. For example, the bonded area between the lower laminate portion 22 and upper laminate portion 24 stays bonded such that the bonded area is removed as the tab 26 is pulled. This remnant of the lower laminate portion 22 can function as a spout to guide the contents of the container when poured. For instance, FIG. 8 illustrates a liquid being poured from the container while FIG. 9 illustrates a powder being poured from the container. Such configurations can be used to restrict or control the flow of the fill in the case of both solids or liquids without the risk of corrosion since the remaining material on the container does not contain aluminum.

In case where the remnant does not extend across the opening, since the induction heating layer is positioned in the upper laminate, any remnant on the container may not contain the induction heating layer. For example, if a portion of the lower laminate ruptures, as can happen with traditional seals, the remnant on the container should not have any induction layer material as it should be removed with the upper laminate portion. This can be beneficial as many induction heating layers include metals, such as aluminum foil. By not having metal foil remain on the container, the container may be more readily recycled. Further, the container may provide a more desirable appearance as no foil remains on the land area.

In some forms, the heat seal layer may have a differential peel functionality. In this regard, a first portion of the heat seal may provide a first, relatively strong bonding force, while a second portion provides a second, relatively weaker bonding force. This differential in bonding forces can help provide a portion of the lower laminate that remains bonded to the container while a different portion releases from the container. Such a differential in strength can also direct forces to cleanly tear the lower laminate portion and provide the spout described above.

In one form, such as for the embodiments shown in FIGS. 8 and 9, the differential peel may be applied across different portions of the seal. In one form, a first adhesive is applied across approximately 50% of the seal while a second, stronger adhesive is applied across the remaining 50% of the seal. The stronger adhesive can be applied in an area under the tabbed portion while the weaker, first adhesive can be applied across a remainder of the seal. In this form, the stronger adhesive will cause the portion under the tab to remain adhered while the remainder of the seal is removed. This can help provide for the remnant functioning as a spout or guide. For example, in the form shown in FIG. 2, the left-hand half of heat seal for, located under tab 32 may be a relatively stronger adhesive material while the right-hand half of heat seal 40 is a relatively weaker adhesive material. In other forms, the heat seal material may be the same, but includes a release material in a portion to create the relatively weaker bond strength with the container. It should be appreciated that the differential adhesive concept discussed above can be included in any of the heat seals, laminates, seals, etc. described herein.

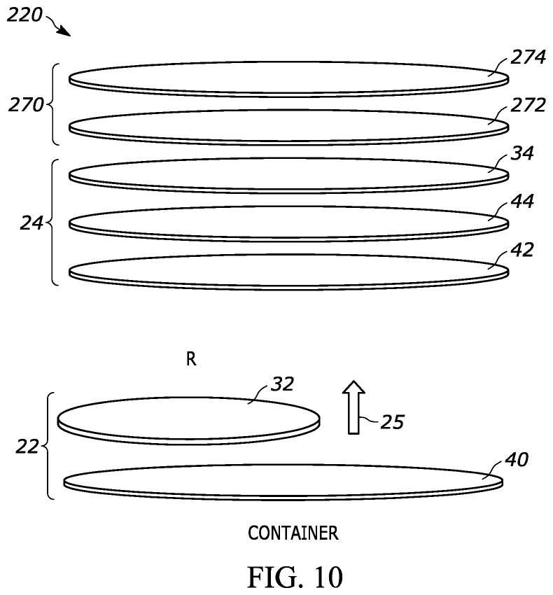

Yet another embodiment is shown in FIG. 10. In this form, the tabbed sealing member 220 is a two-piece configuration. In this form, most of the sealing member 20 is similar to that shown in FIG. 2. However, the sealing member 220 further includes a liner portion 270. The liner portion 270 includes a bonding layer 272, such as a wax layer, and a liner 274. The liner may take a variety of forms such as paper, cardboard, polymer, and the like. In one form, the liner 274 is paper or cardboard while the bonding layer 272 is wax. In this form, the bonding layer 272 bonds the liner 274 to the upper portion 24. During installation of the sealing member 220 on a container, heat can be applied such that the bond between the liner portion 270 and the upper laminate portion 24 is weakened or eliminated. In one form, the bonding layer 272, such as a wax layer, can be absorbed by the liner 274, such as a paper layer.

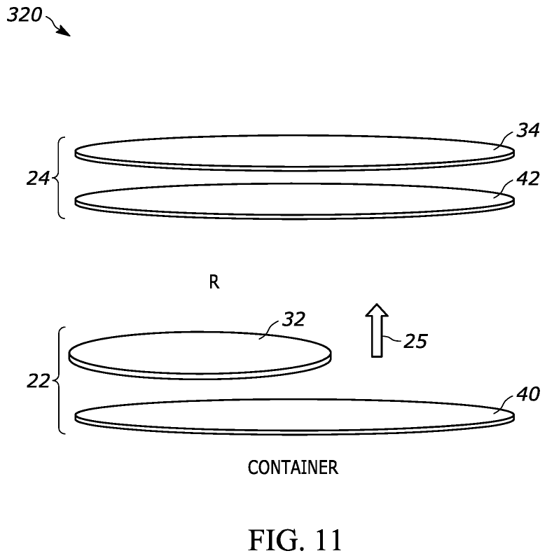

A further form is shown in FIG. 11. This form is similar to the form found in FIG. 2, but eliminates the insulating layer 44. In other words, the upper laminate portion 24 does not include insulating layer 44. It should be appreciated that the features and layers described in any embodiments may be used in any other embodiments as desired.

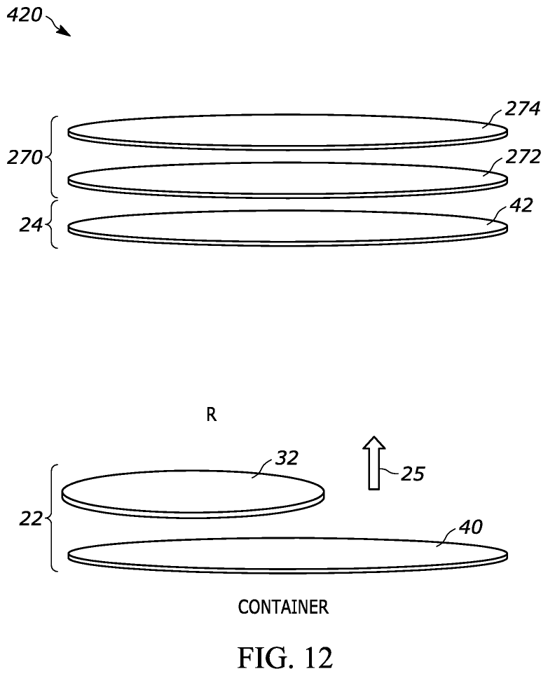

Yet another form is shown in FIG. 12. This form is similar to the form in FIG. 10 in that it is a two-piece configuration. However, the tabbed seal 420 does not include a support layer 34 or insulation layer 44. Instead, the upper laminate portion 24 in FIG. 12 includes the induction heating layer 24.

In some forms, when the lower laminate portion 22 does not include an induction heating layer, the lower laminate may or may not provide sufficient barrier properties. Such barrier properties include, but are not limited to, oxygen barrier, moisture barrier, and the like. However, in some forms it may be desirable to increase these properties without adding a metal foil layer. In such forms, barrier films and/or coatings may be used. Such materials include, but are not limited to SiOx, AlOx, EVOH, and combinations thereof.

As described above, the upper and lower laminate portions may include a variety of layers. The layers may include different polymer materials, such as films, foams, papers, combinations thereof, and the like. In one form, the polymer support layer 34 may take a variety of forms such as polymer films, foams, and combinations thereof. Similarly, the insulating layer may take a variety of forms such as polymer films, foams, paper, and combinations thereof. In one form, the support layer is a polymer film while the insulating layer is a polymer foam. The layers could be built using various backings, various HDPE foams at a variety of different densities. Other paper or fibrous materials could also be used in the upper laminate for insulation since fracture strength is no longer an issue compared to the lower laminate portion.

It should be appreciated that by moving at least some of these layers into the upper laminate portion, the thicknesses of the layers may be downgauged. For example, when a polymer foam layer is included in the lower laminate portion, it typically would need to be thicker and/or stronger so as to not fail or rupture during seal removal. In many of the present forms, foam layers may not be included in the lower laminate such that when included in the upper laminate, the foam can be much thinner than in traditional seals.

As discussed above, the lower laminate portion can include materials that are transparent, translucent, and a combination thereof. In this regard, a user may view the contents of the container through at least a part of the lower laminate portion.

Further, in some forms, it may be possible to eliminate the induction heating layer entirely and build a similar liner system that is applied via conduction sealing.

The embodiments described herein may also provide for other advantages. For example, by moving certain layers to the upper laminate portion, a lower density foam can be used without fault of fracture during liner removal since the foam may be positioned in the upper laminate or otherwise is better supported in the lower laminate. Further, a differential bond strength may provide for easier seal removal.

Additionally, a reduction in removal torque of the closure may be possible due to roughness of top surface of seal. Similarly, there may be improved interaction with reseal liners due to roughness of top surface of the seal. The roughness may be provided from the foam and/or film layers that are positioned towards the top of the laminate structure instead of being positioned in the lower laminate.

Further, as noted above, the seal may provide for visibility of the container contents by the consumer. Similarly, the seal may provide for visibility of tab print within the lined closure. This could aid in having a visual inspection of the tab within the closure and/or using the tab to label liners with a sealant type.

It should be appreciated that, in some forms, when the tabbed seal is removed from the container, a portion of the seal may remain on the container, such as the land area. However, since the foil is in the upper portion, the remainder on the container will typically be free of metal foil and may be substantially polymer materials. In this form, the container may be more suitable for recycling as there is no metal foil to contaminate or otherwise complicate the recycling process.

In some forms, the lower laminate portion includes few layers. For instance, the lower laminate portion may include a single layer, such as the adhesive layer. In another form, the lower laminate portion may include a tab layer, which may be a partial layer. Therefore, in some forms, the lower laminate portion does not include additional layers.

The liner design can be made in various ways, adhesion can be achieved using extrusion, thermal bonding, or even traditional polyurethane adhesive chemistry.

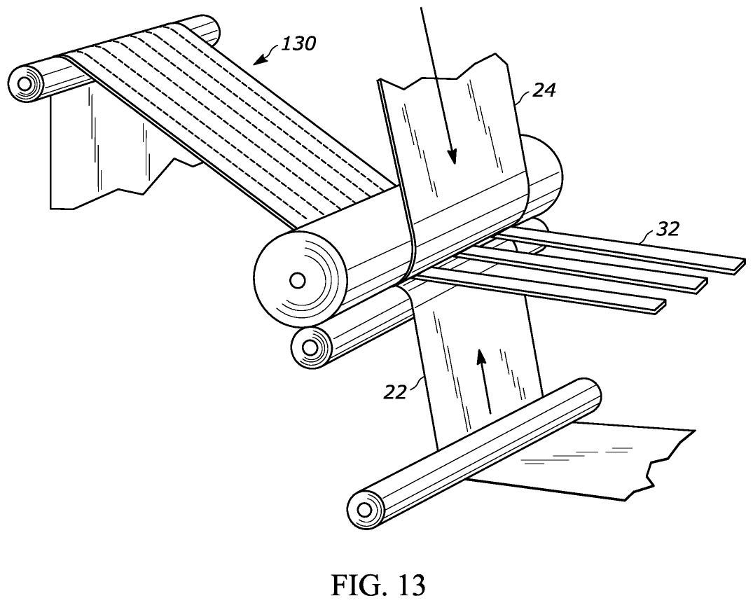

The sealing members herein may be formed from laminates whereby the laminates are slit and or cut into the final sealing members. FIG. 13 illustrates one form of assembling a laminate used to form a sealing member. In this form, the upper laminate portion 24 is joined with the lower laminate portion 22 with the tab layer 32 therebetween to form a laminate 130. The laminate 130 can then be slit and/or cut to form the individual sealing members. The individual sealing members can take a variety of shapes, such as disc shaped.

Further general details of the tabbed seals and layers are provided below.

Additional layers may be included in the upper and/or lower laminate such as polyethylene terephthalate (PET), nylon, or other structural polymer layer and may be, in some approaches, about 0.5 to about 1 mil thick. In some approaches, additional layers may be included in the lower laminate. It should be appreciated that the lower seal laminate may include any number of other layers, such as polymer layers, adhesives, polymer films, polymer foams and the like.

The lower sealant or heat seal layer may be composed of any material suitable for bonding to the rim of a container, such as, but not limited to, induction, conduction, or direct bonding methods. Suitable adhesives, hot melt adhesives, or sealants for the heat sealable layer include, but are not limited to, polyesters, polyolefins, ethylene vinyl acetate, ethylene-acrylic acid copolymers, surlyn, and other suitable materials. By one approach, the heat sealable layer may be a single layer or a multi-layer structure of such materials about 0.2 to about 3 mils thick. By some approaches, the heat seal layer is selected to have a composition similar to and/or include the same polymer type as the composition of the container. For instance, if the container includes polyethylene, then the heat seal layer would also contain polyethylene. If the container includes polypropylene, then the heat seal layer would also contain polypropylene. Other similar materials and combinations are also possible. In some forms, the heat seal may include multiple materials, such as an adhesive material and a support material.

The polymer layers used in the upper and/or lower laminates may take a variety of forms such as coatings, films, foams, and the like. Suitable polymers include but are not limited to, polyethylene, polypropylene, ethylene-propylene copolymers, blends thereof as well as copolymers or blends with higher alpha-olefins. By one approach, one or more of the polymer layers may be a blend of polyolefin materials, such as a blend of one or more high density polyolefin components combined with one or more lower density polyolefin components. In one form, one polymer layer may be a polyethylene film while another polymer layer may be a PET film. According to one form, the polyethylene film may have a thickness of about 5 to about 20 microns while the PET film may have a thickness of about 5 to about 20 microns.

A support layer may be optional in the laminate. If included, it may be polyethylene terephthalate (PET), nylon, or other structural polymer layer and may be, in some approaches, about 0.5 to about 1 mil thick.

The induction heating (membrane) layer may be one or more layers configured to provide induction heating and/or barrier characteristics to the seal. A layer configured to provide induction heating is any layer capable of generating heat upon being exposed to an induction current where eddy currents in the layer generate heat. By one approach, the membrane layer may be a metal layer, such as, aluminum foil, tin, and the like. In other approaches, the membrane layer may be a polymer layer in combination with an induction heating layer. The membrane layer may also be or include an atmospheric barrier layer capable of retarding the migration of gases and moisture at least from outside to inside a sealed container and, in some cases, also provide induction heating at the same time. Thus, the membrane layer may be one or more layers configured to provide such functionalities. By one approach, the membrane layer is about 0.3 to about 2 mils of a metal foil, such as aluminum foil, which is capable of providing induction heating and to function as an atmospheric barrier.

In some forms, the seals may include an insulation layer or a heat-redistribution layer. In one form, the insulation layer may be a foamed polymer layer. Suitable foamed polymers include foamed polyolefin, foamed polypropylene, foamed polyethylene, and polyester foams. In some forms, these foams generally have an internal rupture strength of about 2000 to about 3500 g/in. In some approaches, the foamed polymer layer 106 may also have a density less than 0.6 g/cc and, in some cases, about 0.4 to less than about 0.6 g/cc. In other approaches, the density may be from about 0.4 g/cc to about 0.9 g/cc. The foamed polymer layer may be about 1 to about 5 mils thick.

In other approaches, a non-foam heat distributing or heat re-distributing layer may be included. In such approach, the non-foam heat distributing film layer is a blend of polyolefin materials, such as a blend of one or more high density polyolefin components combined with one or more lower density polyolefin components. Suitable polymers include but are not limited to, polyethylene, polypropylene, ethylene-propylene copolymers, blends thereof as well as copolymers or blends with higher alpha-olefins. By one approach, the non-foam heat distributing polyolefin film layer is a blend of about 50 to about 70 percent of one or more high density polyolefin materials with the remainder being one or more lower density polyolefin materials. The blend is selected to achieve effective densities to provide both heat sealing to the container as well as separation of the liner from the seal in one piece.

The heat-activated bonding layer may include any polymer materials that are heat activated or heated to achieve its bonding characteristics or application to the seal. By one approach, the heat-activated bonding layer may have a density of about 0.9 to about 1.0 g/cc and a peak melting point of about 145° F. to about 155° F. A melt index of the bonding layer 120 may be about 20 to about 30 g/10 min. (ASTM D1238). Suitable examples include ethylene vinyl acetate (EVA), polyolefin, 2-component polyurethane, ethylene acrylic acid copolymers, curable two-part urethane adhesives, epoxy adhesives, ethylene methacrylate copolymers, polybutylene, combinations thereof, and the like bonding materials.

The adhesives useful for any of the adhesive or tie layers described herein include, for example, ethylene vinyl acetate (EVA), polyolefins, 2-component polyurethane, ethylene acrylic acid copolymers, curable two-part urethane adhesives, epoxy adhesives, ethylene methacrylate copolymers, polybutylene, combinations thereof, and the like bonding materials. Other suitable materials may include low density polyethylene, ethylene-acrylic acid copolymers, and ethylene methacrylate copolymers. By one approach, any optional adhesive layers may be a coated polyolefin adhesive layer. If needed, such adhesive layers may be a coating of about 0.2 to about a 0.5 mil (or less) adhesive, such as coated ethylene vinyl acetate (EVA), polyolefins, 2-component polyurethane, ethylene acrylic acid copolymers, curable two-part urethane adhesives, epoxy adhesives, ethylene methacrylate copolymers and the like bonding materials.

In one aspect, the tab may be formed by a full layer or partial layer of material combined with a partial width composite adhesive structure that includes a polyester core with upper and lower adhesives on opposite sides thereof. This partial composite adhesive structure bonds the upper laminate to the lower laminate to form the gripping tab.

In other aspects of this disclosure, the upper laminate of the seal does not extend the full width of the sealing member in order to define the gripping tab. To this end, the pull-tab sealing members herein may also combine the advantages of a tabbed sealing member with a large gripping tab defined completely within the perimeter of the seal, but achieve such functionality with less material (in view of the part layers of the upper laminate) and permit such a tab structure to be formed on many different types of pre-formed lower laminates. The partial upper laminate structure is advantageous, in some approaches, for use with a seal configured for large or wide mouth containers, such as containers with an opening from about 30 to about 100 mm (in other approaches, about 60 to about 100 mm). These seals may also be used with 38 mm or 83 mm container openings, or can be used with any sized container.

In further aspects of this disclosure, the sealing members herein may include a pull or grip tab defined in the upper laminate portion wholly within a perimeter or circumference of the sealing member wherein an upper surface of the sealing member is partially defined by the upper laminate portion and partially defined by the lower laminate portion. In one approach of this aspect, the top surface of the sealing member is provided by a minor portion of the upper laminate and a major portion of the lower laminate. In other approaches of this aspect, the lower laminate is partially exposed at a top surface of the seal with about 50 percent to about 75 percent (or more) of the lower laminate exposed at the top surface of the entire seal. The seals of this aspect allow consumers to remove the sealing member using the tab (as in a conventional pull-tab seal) and/or puncture the sealing member by piercing the exposed lower laminate portion to provide push/pull functionality depending on the preference of the consumer.

In the various embodiments, the seals of the present disclosure defining a tab wholly within a perimeter or circumference of the seal (formed by a full or partial layer) also provide an improved ability for the tabbed sealing member to function in a two-piece seal and liner combination. In a two-piece seal and liner combination, the tabbed sealing member is temporarily adhered across its top surface to a liner. After container opening and removal of a cap or closure, the sealing member stays adhered to the container mouth and the liner separates and remains in the container's cap.

In some prior versions of two-piece seal and linear assemblies, the bottom layer of the sealing member is a heat seal layer that is activated by heating, such as by induction or conduction heating, in order to adhere or bond an outer periphery of the sealing member to a rim surrounding the mouth of a container. In the two-piece seal and liner combination, an upper surface of the sealing member is temporarily adhered to a lower surface of the liner by a release layer, which is often a heat-activated release layer, such as an intervening wax layer. During heating to bond the sealing member to the container, heat not only activates the lower heat seal layer, but also travels upwardly through the seal to melt the intervening wax across the entire surface of the sealing member to separate the liner from the sealing member. Often, the melted wax is absorbed by the liner in order to permit easy liner separation from the sealing member. As can be appreciated, for this sealing member and liner combination to function properly, the intervening wax layer needs to be melted across the entire surface of the sealing member. If the wax is not melted evenly all the way across the sealing member upper surface, the liner may not properly separate from the lower seal portion.

The various layers of the sealing member are assembled via coating adhesives, applying films, coextrusion, and/ or a heat lamination process forming a sheet of the described layers. Extrusion lamination may also be used. The resulting laminate sheet of the sealing members can be cut into appropriate sized disks or other shapes as needed to form a vessel closing assembly or tabbed sealing member. The cut sealing member is inserted into a cap or other closure which, in turn, is applied to the neck of a container to be sealed. The screw cap can be screwed onto the open neck of the container, thus sandwiching the sealing member between the open neck of the container and the top of the cap. The sealing layer may be a pressure sensitive adhesive, the force of attaching the closure to the container can activate the adhesive.

### EXAMPLES

Initial prototypes have been built for PET containers in the laboratory using the thermal process and a trial design has been developed. Many of the prototypes have been induction sealed in the lab. The seal was found to hold about 30 psi when tested on a Mocon package integrity analyzer. Samples were sealed onto water filled containers and frozen and thawed. They did not show seal breach.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of Applicant's contribution. The actual scope of the protection sought is intended to be defined in the following claims when viewed in their proper perspective based on the prior art.

What is claimed is:

1. A tabbed sealing member for sealing to a rim surrounding a container opening, the sealing member comprising:
a multi-layer laminate including an upper laminate portion partially bonded to a lower laminate portion forming a gripping tab, the gripping tab configured for removing the sealing member from the container opening,
the lower laminate portion positioned below the gripping tab and including at least a heat seal layer for bonding to the container rim, and
the upper laminate including an induction heating layer for providing heat to the heat seal layer in the lower laminate portion.

2. The tabbed sealing member of claim 1 further comprising an insulating layer in the upper laminate.

3. The tabbed sealing member of claim 1 further comprising a polymer foam layer and a polymer film layer.

4. The tabbed sealing member of claim 1 wherein the heat seal layer comprises a first adhesive portion providing a first adhesive strength and a second adhesive portion having a second adhesive strength, the second adhesive strength being greater than the first adhesive strength.

5. The tabbed sealing member of claim 1 wherein the lower laminate portion is free of metal foil.

6. The tabbed sealing member of claim 1 wherein at least a portion of the lower laminate portion is one of transparent, translucent, and a combination thereof.

7. The tabbed sealing member of claim 1 wherein at least a portion of the lower laminate is configured to remain on a container when the tabbed sealing member is removed from the container to form a pour spout.

8. The tabbed sealing member of claim 1 further comprising a liner portion positioned above the upper laminate portion, the liner portion being separable from the upper laminate portion.

9. The tabbed sealing member of claim 1 wherein the lower laminate portion further includes a barrier film selected from the group consisting of SiOx, AlOx, EVOH, and combinations thereof.

10. The tabbed sealing member of claim 1 wherein the lower laminate portion consists of the heat seal layer and an optional tab layer.

11. The tabbed sealing member of claim 1 wherein the lower laminate portion further comprises a support layer.

12. A laminate for forming a tabbed sealing member, the laminate comprising:
an upper laminate portion partially bonded to a lower laminate portion configured to form a gripping tab when the laminate is formed into the sealing member;
the lower laminate portion positioned below the upper portion and including at least a heat seal layer for bonding to a container rim; and
the upper laminate including an induction heating layer for providing heat to the heat seal layer in the lower laminate portion.

13. The laminate of claim 12 wherein the upper laminate portion further includes an insulating layer.

14. The laminate of claim 12 further comprising a polymer foam layer and a polymer film layer.

15. The laminate of claim 12 wherein the heat seal layer comprises a first adhesive portion providing a first adhesive strength and a second adhesive portion providing a second adhesive strength, the second adhesive strength being greater than the first adhesive strength.

16. The laminate of claim 12 wherein the lower laminate portion is free of metal foil.

17. The laminate of claim 12 wherein at least a portion of the lower laminate portion is one of transparent, translucent, and a combination thereof.

18. The laminate of claim 12 further comprising a liner portion positioned above the upper laminate portion, the liner portion being separable from the upper laminate portion.

19. The laminate of claim 12 wherein the lower laminate portion further includes a barrier film selected from the group consisting of SiOx, AlOx, EVOH, and combinations thereof.

20. The laminate of claim 1 wherein the lower laminate portion consists of the heat seal layer and an optional tab layer.

21. The laminate of claim 1 wherein the lower laminate portion further comprises a support layer.

22. A tabbed sealing member system comprising:
a container having a land area;
a multi-layer laminate including an upper laminate portion partially bonded to a lower laminate portion forming a gripping tab, the gripping tab configured for removing the sealing member from the container land area,
the lower laminate portion positioned below the gripping tab and including at least a heat seal layer for bonding to the container land area, and
the upper laminate including an induction heating layer for providing heat to the heat seal layer in the lower laminate portion.

23. The tabbed sealing member system of claim 22 wherein the lower laminate portion is free of metal foil.

24. The tabbed sealing member system of claim 22 wherein the heat seal layer comprises a plurality of adhesive portions, a first adhesive portion configured to provide a first bond strength to the container rim when installed, and a second adhesive portion configured to provide a second bond strength to the container rim when installed, the second bond strength being greater than the first bond strength to provide a differential peel of the heat sealing layer.
